(19) United States
(12) Patent Application Publication
(10) Pub. No.: US 2026/0356305 A1
(43) Pub. Date: Nov. 12, 2026

(54) INTERIOR TRIM FOR A VEHICLE DOOR WITH A HORIZONTALLY ARRANGED OPERATING LEVER FOR UNLOCKING THE DOOR LOCK, AND OPERATING LEVER WITH A GRIPPING EDGE PROVIDED FOR THIS PURPOSE

(71) Applicant: VOLKSWAGEN AKTIENGESELLSCHAFT, Wolfsburg (DE)

(72) Inventors: Harald HEIN, Schöningen (DE); Uwe JÜRGES, Braunschweig (DE); Lutz KAHL, Wolfsburg (DE); Thomas ULBRICH, Hamburg (DE)

(21) Appl. No.: 19/126,009

(22) PCT Filed: Nov. 23, 2023
(86) PCT No.: PCT/EP2023/082847

§ 371 Date: Apr. 30, 2025

(30) Foreign Application Priority Data
Nov. 29, 2022 (DE) 10 2022 212 807.9

(51) Int. Cl. B60R 13/02; E05B 85/12

(52) U.S. Cl. CPC B60R 13/0243; E05B 85/12; B60R 2013/0287

(57) ABSTRACT

An interior trim for a transportation vehicle door, having an operating lever for unlocking the door lock, wherein the operating lever is arranged horizontally and is mounted pivotably about a horizontal pivot axis. The operating lever has, at its front end, an upwardly shaped gripping edge at which the door lock can be unlocked by applying a pulling force.

### PRIORITY CLAIM

This patent application is a U.S. National Phase of International Patent Application No. PCT/EP2023/082847, filed 23 Nov. 2023, which claims priority to Patent Application No. 10 2022 212 807.9, filed 29 Nov. 2022, the disclosures of which are incorporated herein by reference in their entireties.

### SUMMARY

Illustrative embodiments relate to an interior trim for a transportation vehicle door, having an operating lever for unlocking the door lock, wherein the operating lever is arranged horizontally and is mounted pivotably about a horizontal pivot axis. The illustrative embodiments also relate to a transportation vehicle door and to an operating lever.

### BRIEF DESCRIPTION OF THE DRAWINGS

Exemplary embodiments will be described in more detail below with reference to drawings, in which:

FIG. 1 shows a detail of an interior trim with an armrest and an operating lever for unlocking the door lock.

FIG. 2 shows a possible exemplary embodiment of the operating lever for unlocking the door lock and;

FIG. 3 shows analogously to FIG. 2, another possible exemplary embodiment of the operating lever.

### DETAILED DESCRIPTION

In order for it to be possible to open the transportation vehicle door of a motor transportation vehicle from the transportation vehicle interior, an operating lever is usually arranged on the door inner side, the operating lever being coupled to a mechanical and/or electric device for unlocking the door lock. Such an operating lever is also referred to as an interior door actuator. The operating lever is usually a constituent of a door interior trim (referred to only as interior trim in the following text).

DE 10 2008 049 118 A1 describes a transportation vehicle door in a transportation vehicle, the door having an operating lever for opening the transportation vehicle door. Opening is effected by pulling on the operating lever. The operating lever is arranged horizontally or substantially horizontally and mounted pivotably about a horizontally extending pivot axis.

### SUMMARY

Disclosed embodiments provide an operating lever of the interior trim that exhibits better actuating ergonomics, a transportation vehicle door, a transportation vehicle side door, which has an interior trim, and to an operating lever designed.

Disclosed embodiments provide interior trim for a transportation vehicle door, a transportation vehicle side door, has an operating lever for unlocking the door lock (of the transportation vehicle door), wherein the operating lever is arranged horizontally or substantially horizontally and is mounted pivotably about a horizontal or substantially horizontal axis of rotation or pivot axis. The operating lever has, at its front end, an upwardly shaped gripping edge. At the gripping edge, a pulling force can be applied relatively easily in order to unlock the door lock.

### BRIEF DESCRIPTION OF THE FIGURES

The disclosed embodiment is explained in more detail in the following text by way of example and in a nonlimiting manner with reference to the figures. The features shown in the figures and/or explained in the following text may be general features of the disclosed embodiment, including independently of specific combinations of features, and accordingly develop the disclosed embodiment.

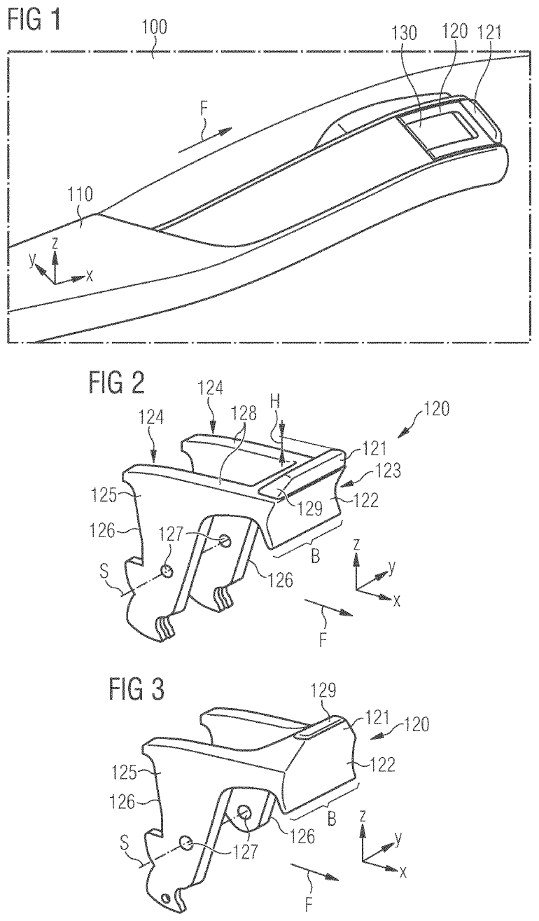

FIG. 1 illustrates an interior trim for a transportation vehicle door (for example, the left-hand front door or driver's door) has a hand rest or armrest.

FIGS. 2 and 3 illustrate the operating lever arranged horizontally and mounted pivotably about a horizontal pivot axis, wherein FIG. 2 shows a perspective illustration of one possible exemplary embodiment of the operating lever and FIG. 3 shows another possible exemplary embodiment of the operating lever.

### DETAILED DISCLOSURE

Disclosed embodiments provide an operating lever of the interior trim that exhibits better actuating ergonomics, a transportation vehicle door, a transportation vehicle side door, which has an interior trim, and to an operating lever designed.

Disclosed embodiments provide interior trim for a transportation vehicle door, a transportation vehicle side door, has an operating lever for unlocking the door lock (of the transportation vehicle door), wherein the operating lever is arranged horizontally or substantially horizontally and is mounted pivotably about a horizontal or substantially horizontal axis of rotation or pivot axis. The operating lever has, at its front end, an upwardly shaped gripping edge. At the gripping edge, a pulling force can be applied relatively easily in order to unlock the door lock.

The operating lever is arranged in particular such that its front end is directed forward, i.e., in the direction of travel (of the transportation vehicle). Starting from its horizontal rest position or normal position, the operating lever can be gripped with one or more fingers at its front end and pivoted (in order to unlock the door lock or open the transportation vehicle door) by applying a pulling force with the fingers. An upwardly shaped or upwardly directed and in particular also forwardly inclined gripping edge is formed at the front end of the operating lever, in particular at the transition or in the transitional region between a (front) end side (or an end side located at the front in the direction of travel) and a top side of the operating lever. The gripping edge is designed in particular in a hump-like manner or as a hump which protrudes upwardly (i.e., in the transportation vehicle vertical direction) beyond the top side and optionally also forwardly (i.e., in the direction of travel or in the transportation vehicle longitudinal direction) beyond the end side. The protrusion beyond the top side measures 4 mm to 8 mm, such that the gripping edge is readily tangible and easy to grip.

Optionally, the operating lever has, on its (front) end side, a concavely shaped recess or gripping recess which is arranged below the gripping edge. In particular, provision is made for the gripping edge and the gripping recess to transition seamlessly or in a tangentially constant manner into one another. The gripping recess may have a horizontal orientation and extends in particular across the entire width of the end side. (The width in particular the extension of the operating lever in the transportation vehicle transverse direction). The gripping recess acts as an ergonomic contact face for fingertips bent around the gripping edge, wherein provision is made in particular for the fingertips to need to be bent only through 90° at most. The surface of the gripping recess can be formed with rips, grooves, pimples, indentations or the like, which prevent the fingertips from slipping, or at least make this difficult. The surface of the gripping recess may also have a rubber coating or the like. Otherwise, the gripping edge can also be formed with ribs, grooves, pimples, indentations, a rubber coating or the like.

The gripping edge, in particular in combination with the end-side gripping recess, makes it possible to use the fingers to easily or at least more easily apply a pulling force, acting horizontally or substantially horizontally toward the rear (i.e., counter to the direction of travel), to the operating lever, with the result that the latter is pivoted. Unlocking can take place even at a relatively small pivoting angle of 7° to 15°. The resulting actuating movement feels less like a pivoting movement and more like a translational sliding movement. Overall, the actuating ergonomics are markedly improved.

The gripping edge is formed in a rounded manner, in particular including the transitions to adjacent surface portions. Adjacent surface portions are, in particular, the top side and end side, or the gripping recess, of the operating lever, wherein any transitions to the side surfaces can also be formed in a rounded manner.

The gripping edge may be formed such that it extends across the entire width or substantially across the entire width of the operating lever, this meaning, in particular, the local width of the operating lever at the transition or in the transitional region between the end side and the top side of the operating lever. The gripping edge may, however, also be formed such that it extends only partially across the width of the operating lever.

The gripping edge may have a decorative element, which is in the form of a cap. The decorative element is made from plastic or metal and may improve the visibility, tangibility and/or haptics and make cleaning easier. The decorative element may have been adhesively bonded on or fastened by back injection molding. Furthermore, the gripping edge may also be equipped with illumination.

Optionally, the operating lever has two longitudinal portions, extending in the transportation vehicle longitudinal direction, which are spaced apart from one another, in the transportation vehicle transverse direction, and are connected together by crosspiece at their front ends (with regard to the direction of travel). The gripping edge, also the gripping recess, is/are arranged on the crosspiece or integrated into the crosspiece. The longitudinal portions are formed with a downwardly directed arm, on which the pivot bearings are located. At least one of the arms may also be designed for Bowden cable and/or switch actuation. The clearance between the spaced-apart longitudinal portions reduces the component weight and can also be used for the arrangement of further operating elements. Irrespective of the design, the operating lever, or the body thereof, is formed in one piece, optionally as an injection-molded plastics part.

The interior trim may have an armrest or the like, into which the operating lever is integrated. Provision is made for the armrest to have a horizontal or substantially horizontal support surface with which the top side of the operating lever (in an unactuated normal position) lies flush. A provision is made for the operating lever to be arranged in the front end region of the armrest, optionally such that the front end (with the gripping edge arranged thereon) of the operating lever is located at the front end of the armrest.

In the disclosed embodiments, both the above-described features and those that will be described in the following text are usable not only in the respectively specified combination of features, but also in other combinations of features or on their own. This also applies to the features shown in the figures.

The interior trim 100, shown in FIG. 1, for a transportation vehicle door (for example, the left-hand front door or driver's door) has a hand rest or armrest 110. Integrated into the front end region of the armrest 110, in a manner flush with the substantially horizontal support surface, is an operating lever 120 with which the door lock of the transportation vehicle door is able to be unlocked. The operating lever 120 is U-shaped in plan view and surrounds a further operating element 130.

The operating lever 120 is arranged horizontally and mounted pivotably about a horizontal pivot axis (see FIG. 2 and FIG. 3). By pulling back the operating lever 120, i.e., by applying a pulling force counter to the direction of travel F (x direction), the operating lever 120 is pivoted out of the normal position shown and the door lock is unlocked. At its front end with regard to the direction of travel F, the operating lever 120 has a gripping edge 121 that is upwardly shaped, i.e., shaped in the transportation vehicle vertical direction (z direction), and can be gripped with the fingertips for the ergonomic application of a substantially horizontal pulling force.

FIG. 2 shows a perspective illustration of one possible exemplary embodiment of the operating lever 120 looking toward its front end side. Located at the front end side, below the upwardly formed and forwardly inclined gripping edge 121, is a concave gripping recess 122, which is provided as an ergonomically shaped contact face for the fingertips bent around the gripping edge 121. The operating lever 120 is thus designed so as to favor gripping and can be gripped relatively easily at its front end for application of a pulling force. Unergonomic under-gripping for lifting the operating lever is not necessary and ideally also not possible.

The operating lever 120 also has two longitudinal portions 124 which extend in the transportation vehicle longitudinal direction (x axis), are spaced apart from one another in the transportation vehicle transverse direction (y axis) and are connected together at their front ends by a crosspiece 123, resulting in the U-shaped contour in plan view. The gripping edge 121 and the gripping recess 122 are arranged on the crosspiece 123 or integrated into the crosspiece 123. The longitudinal portions 124 are formed with downwardly directed arms 126 on which the pivot bearings 127 are located. The gripping edge 121 is thus located (in the direction of travel F) in front of the pivot axis S, for example, by 30 mm to 50 mm. Moreover, the two arms 126 are designed for Bowden cable and/or switch actuation at their lower ends. The operating lever 120 has, in the transportation vehicle transverse direction, a width B of 45 mm to 65 mm. The gripping edge 121 extends substantially across the entire width B. The protrusion H of the gripping edge 121 beyond the U-shaped top side 128 measures preferably 4 mm to 8 mm. The gripping edge 121 may have an attached decorative element 129. The operating lever 120 may have (in the transportation vehicle longitudinal direction) an absolute length of 60 mm to 80 mm.

FIG. 3 shows another possible exemplary embodiment of the operating lever 120, which differs from the possible exemplary embodiment in FIG. 2 substantially in that the gripping edge 121 has a different design and extends only partially across the width B, and also in that only one of the two arms 126 is designed for Bowden cable and/or switch actuation.

### LIST OF REFERENCE SIGNS

100 Interior trim
110 Armrest
120 Operating lever
121 Gripping edge
122 Gripping recess
123 Crosspiece
124 Longitudinal portion
125 Side surface
126 Arm
127 Pivot bearing
128 Top side
129 Decorative element
130 Operating element
B Width
F Direction of travel
H Protrusion
S Pivot axis
x/y/z Transportation Vehicle coordinate system

1. An interior trim for a transportation vehicle door, the trim comprising:
an operating lever for unlocking the door lock, the operating lever being arranged horizontally and mounted pivotably about a horizontal pivot axis,
wherein the operating lever has, at its front end, an upwardly shaped gripping edge at which the door lock is unlocked by application of a pulling force.

2. The interior trim of claim 1, wherein the operating lever has, on an end side, a concavely shaped gripping recess arranged below the gripping edge.

3. The interior trim of claim 2, wherein the surface of the gripping recess includes ribs, pimples or a rubber coating.

4. The interior trim of claim 1, wherein the gripping edge extends across the entire width of the operating lever.

5. The interior trim of claim 1, wherein the gripping edge extends only partially across the width of the operating lever.

6. The interior trim of claim 1, wherein the gripping edge has a decorative element.

7. The interior trim of claim 1, wherein the operating lever has two spaced-apart longitudinal portion which are connected together at their front ends by a crosspiece, and wherein the gripping edge is arranged on the crosspiece.

8. The interior trim of claim 1, wherein the interior trim has an armrest, and wherein the operating lever is integrated into the armrest.

9. transportation vehicle door, comprising an interior trim as claimed in claim 1.

10. An operating lever for unlocking a door lock on a transportation vehicle door, the operating lever is configured to be arranged horizontally with a horizontal pivot axis and including, at its front end, an upwardly shaped gripping edge.

11. The transportation vehicle door of claim 9, wherein the transportation vehicle door is a vehicle side door.
